(19) United States
(12) Patent Application Publication
(10) Pub. No.: US 2012/0143442 A1
(43) Pub. Date: Jun. 7, 2012

(54) AUTOMATIC FULL-TURN CONTROL METHOD FOR MDPS

(75) Inventors: Jong Sung Kim, Yongin-si (KR); Dongheon Kwak, Gwangju (KR)

(73) Assignees: Kia Motors Corporation, Seoul (KR); Hyundai Motor Company, Seoul (KR)

(21) Appl. No.: 13/191,989

(22) Filed: Jul. 27, 2011

(30) Foreign Application Priority Data
Dec. 7, 2010 (KR) 10-2010-0124417

(51) Int. Cl. B62D 6/00; B62D 6/08; B62D 6/02; B62D 5/00

(52) U.S. Cl. 701/41

(57) ABSTRACT

An automatic full-turn control method for MDPS includes determining if automatic Full-Turn conditions for the MDPS are satisfied, full turning the MDPS when the automatic Full-Turn conditions for the MDPS are satisfied, determining if automatic Full-Turn releasing conditions for the MDPS are satisfied and releasing the Full-Turn of the MDPS when the releasing conditions for the MDPS are satisfied.

### CROSS-REFERENCE TO RELATED APPLICATION

This application claims priority to and the benefit of Korean Patent Application No. 10-2010-0124417 filed Dec. 7, 2010, the entire contents of which application is incorporated herein for all purposes by this reference.

### BACKGROUND OF INVENTION

1. Field of Invention

The present invention relates to an automatic full-turn control method for MDPS. More particularly, the present invention relates to an automatic full-turn control method for MDPS which may reduce driver's effort to turn a steering wheel in full-turning of a steering wheel such as U-turn and so on.

2. Description of Related Art

Effort for turning a steering wheel may vary from person to person.

While each steering wheel has been developed compatible to each vehicle's characteristic, it has been complained about effort for turning a steering wheel.

Trends in development of vehicle have been focused on safety and minimization of driver's effort and a drain on driver's strength as increasing of drivers of female, disabled person, seniors and so on.

While vehicle makers supply variable steering of power of a steering system to reduce complaining, however driver's request for demanding of easy Full-Turn is increasing.

Particularly, when a vehicle stops a Full-Turn condition is the most drivers' effort demanding condition.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an automatic full-turn control method for MDPS having advantages of assisting driver's effort to turn a steering.

Various aspects of the present invention provide for an automatic full-turn control method for MDPS which may supply convenience to a driver in U-turn or Full-Turn.

An automatic full-turn control method for MDPS according to various aspects of the present invention may include determining if automatic Full-Turn conditions for the MDPS are satisfied, full turning the MDPS when the automatic Full-Turn conditions for the MDPS are satisfied, determining if automatic Full-Turn releasing conditions for the MDPS are satisfied and releasing the Full-Turn of the MDPS when the releasing conditions for the MDPS are satisfied.

The determining conditions of the automatic Full-Turn conditions may include determining if an operation of the MDPS is normal.

Determining conditions of the automatic Full-Turn conditions may include determining if a MDPS Full-Turn switch is on.

The MDPS Full-Turn switch is integrally formed with a turn-signal switch.

The determining conditions of the automatic Full-Turn conditions may include determining if speed of a vehicle is “0” and an elapsed time of which the vehicle's speed is “0” is over a predetermined standard time.

The determining conditions of the automatic Full-Turn conditions may include determining if present shift range is driving range.

The automatic Full-Turn releasing conditions may be determined to be satisfied if any one of steering information including a steering angle condition, a steering angle speed condition and a steering wheel torque condition is satisfied.

The automatic Full-Turn releasing conditions may be determined to be satisfied if any one of driving information including a vehicle speed condition, a vehicle speed change condition, an engine rpm condition, an engine rpm change condition is satisfied.

According to an automatic full-turn control method for MDPS of various aspects of the present invention, in standing by for U-turn and so on, FULL TURN may be automatically executed without turning a steering wheel and thus driver's convenience may be enhanced.

Even female, disabled person and senior driver may execute sharp curve easily so that traffic accident may be prevented.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary control system of automatic full-turn for MDPS according to the present invention.

FIG. 2 is a flowchart of an exemplary automatic full-turn control method for MDPS according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

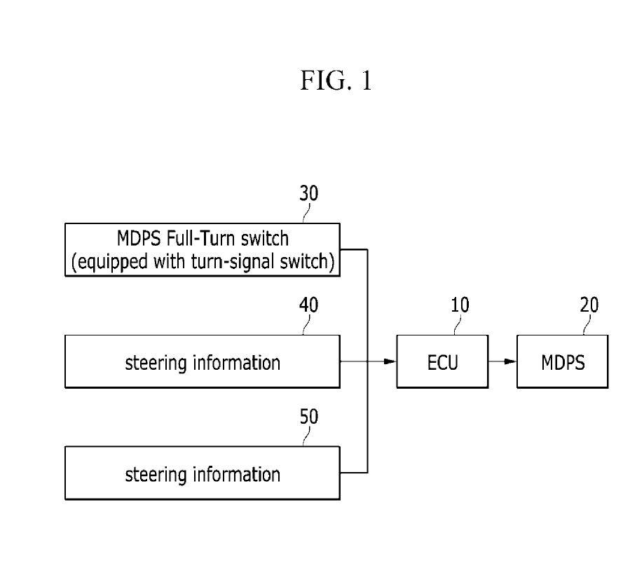

Referring to FIG. 1, a control system of automatic full-turn for MDPS according to various embodiments of the present invention includes an ECU (electric control unit; 10), a MDPS (Motor Driven Power Steering) 20 controlled by the ECU 10, a MDPS Full-Turn switch 30 supplying MDPS Full-Turn executing signal to the ECU 10, a plurality of sensors or maps including steering information 40 and a plurality of sensors or maps including driving information 50.

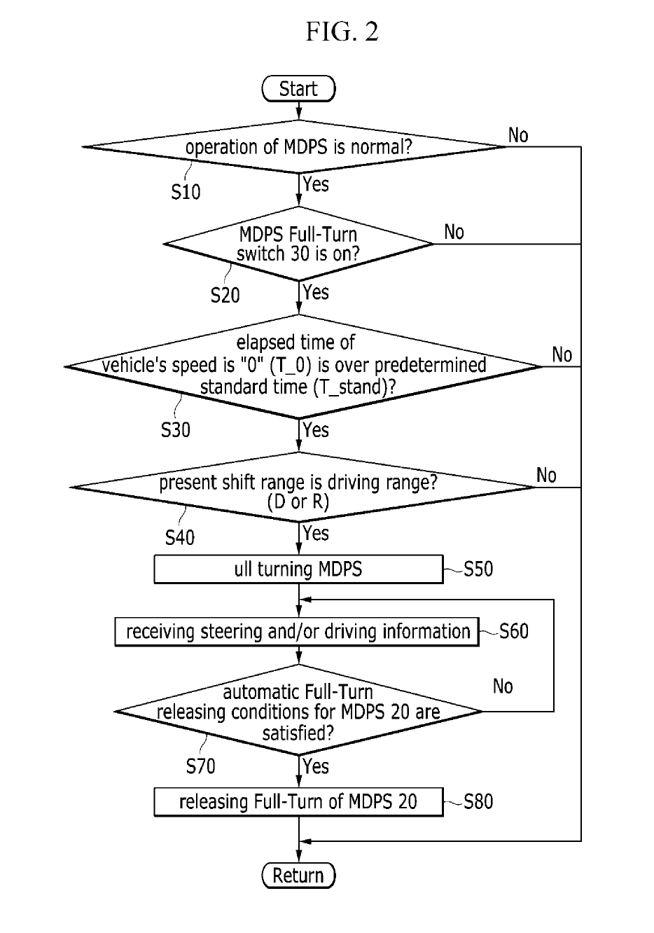

Referring to FIG. 1 and FIG. 2, an automatic full-turn control method for the MDPS according to various embodiments of the present invention includes determining if automatic Full-Turn conditions for the MDPS 20 are satisfied, full turning the MDPS 20 when the automatic Full-Turn conditions for the MDPS are satisfied (S50), determining if automatic Full-Turn releasing conditions for the MDPS 20 are satisfied (S70) and releasing the Full-Turn of the MDPS 20 when the releasing conditions for the MDPS 20 are satisfied (S80).

The full turning the MDPS 20 (S50) means that a motor of the MDPS 20 is controlled for steering angle of a steering wheel of the MDPS 20 to be maximized.

The determining conditions of the automatic Full-Turn conditions include determining if an operation of the MDPS is normal (S10).

That is, only in the case the operation of the MDPS 20 is normal, the full turning the MDPS 20 (S50) is executed so that traffic accident due to malfunction of a steering wheel may be prevented.

The determining conditions of the automatic Full-Turn conditions include determining if a MDPS Full-Turn switch 30 is on (S20).

The MDPS Full-Turn switch 30 may be integrally formed with a turn-signal switch.

That is, the MDPS Full-Turn switch 30 may be a separate switch or the MDPS Full-Turn switch 30 may be integrally formed with a turn-signal switch, which may manipulate the turn-signal switch as two steps to indicate for turn-signals and the MDPS Full-Turn signal. In this case, for example, to indicate for turn-signals and the MDPS Full-Turn signal, a first step may indicate direction of a vehicle and a second step may indicate the MDPS Full-Turn signal such as U-turn signals or rapid steering signals.

The determining conditions of the automatic Full-Turn conditions include determining if speed of a vehicle is “0” and an elapsed time of which the vehicle's speed is “0” is over a predetermined standard time (S30).

That is, when a vehicle is in driving, the automatic full-turn control method according to various embodiments of the present invention is not executed so that traffic accident due to malfunction of a steering wheel may be prevented.

When the elapsed time of which the vehicle's speed is “0” is over a predetermined standard time, for example, 2 seconds, it is determined that a vehicle is on standby for U-turn and so on and the automatic full-turn control method according to various embodiments of the present invention is executed.

The determining conditions of the automatic Full-Turn conditions include determining if present shift range is driving range (S40).

In this case, the driving range means shift ranges except for N-shift and P-shift. And only in the case the vehicle is in the driving range, it is determined that a driver is preparing the U-turn and so on.

The automatic Full-Turn releasing conditions are determined to be satisfied if any one of steering information including a steering angle condition, a steering angle speed condition and a steering wheel torque condition is satisfied (S80).

If a driver's intention intervene during the U-turn as turning a steering wheel and so on, it is determined that the U-turn is completed or driver wishes to terminate the Full-Turn and thus the automatic Full-Turn of the MDPS is released (S80).

The automatic Full-Turn releasing conditions are determined to be satisfied if any one of driving information including a vehicle speed condition, a vehicle speed change condition, an engine rpm condition, an engine rpm change condition is satisfied (S80).

If a driver's intention intervene during the U-turn as accelerating a vehicle over a predetermined speed and so on, it is determined that the U-turn is completed or driver wishes to terminate the Full-Turn and thus the automatic Full-Turn of the MDPS is released (S80).

The steering information and the driving information may be determined considering a kind of a vehicle, road conditions, driver's driving habits and so on.

As described above, only when a vehicle speed is zero and it is determined to be required as indicated by a switch and so on, the automatic full-turn control method for a MDPS according to various embodiments of the present invention is executed, and thus the control method contributes to safe driving and alleviates driver's burden of rapid turning of a steering wheel such as U-turn, parking and so on.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An automatic full-turn control method for Motor Driven Power Steering (MDPS) comprising:
determining if automatic Full-Turn conditions for the MDPS are satisfied;
full turning the MDPS when the automatic Full-Turn conditions for the MDPS are satisfied;
determining if automatic Full-Turn releasing conditions for the MDPS are satisfied; and
releasing the Full-Turn of the MDPS when the releasing conditions for the MDPS are satisfied.

2. The automatic full-turn control method of claim 1, wherein the determining conditions of the automatic Full-Turn conditions comprises:
determining if an operation of the MDPS is normal.

3. The automatic full-turn control method of claim 1, the determining conditions of the automatic Full-Turn conditions comprises:
determining if a MDPS Full-Turn switch is on.

4. The automatic full-turn control method of claim 3, wherein the MDPS Full-Turn switch is integrally formed with a turn-signal switch.

5. The automatic full-turn control method of claim 1, the determining conditions of the automatic Full-Turn conditions comprises:
determining if speed of a vehicle is “0” and an elapsed time of which the vehicle's speed is “0” is over a predetermined standard time.

6. The automatic full-turn control method of claim 1, the determining conditions of the automatic Full-Turn conditions comprises:
determining if present shift range is driving range.

7. The automatic full-turn control method of claim 1, wherein the automatic Full-Turn releasing conditions are determined to be satisfied if any one of steering information including a steering angle condition, a steering angle speed condition and a steering wheel torque condition is satisfied.

8. The automatic full-turn control method of claim 1, wherein the automatic Full-Turn releasing conditions are determined to be satisfied if any one of driving information including a vehicle speed condition, a vehicle speed change condition, an engine rpm condition, an engine rpm change condition is satisfied.
